(19) United States
(12) Patent Application Publication
(10) Pub. No.: US 2021/0222749 A1
(43) Pub. Date: Jul. 22, 2021

(54) Upholstery Spring, Method For Producing An Upholstery Spring, Mattress, And Upholstered Furniture

(71) Applicant: Agro Holding GmbH, Bad Essen (DE)

(72) Inventor: Sabine Grothaus, Bad Essen (DE)

(21) Appl. No.: 16/096,775

(22) PCT Filed: Apr. 19, 2017
(86) PCT No.: PCT/EP2017/059218

§ 371 Date: Oct. 26, 2018

(30) Foreign Application Priority Data
Apr. 26, 2016 (DE) 10 2016 107 746.1

(51) Int. Cl. F16F 1/02; A47C 23/043; F16F 1/04; C21D 8/06; C21D 9/52; B21F 35/00; B21F 3/02

(52) U.S. Cl. CPC F16F 1/024; A47C 23/043; F16F 1/021; F16F 1/04; F16F 2230/02; C21D 9/525; B21F 35/00; B21F 3/02; F16F 2230/0047; C21D 8/065

(57) ABSTRACT

An upholstery spring comprises a steel spring wire made of a microalloyed steel and a color indicator arranged thereon at least in some regions, the microalloyed steel containing between 0.004 to 0.015 wt.-% of one or more alloy elements. The invention further relates to a method for producing an upholstery spring, a mattress or a piece of upholstered furniture having such an upholstery spring.

The present invention relates to an upholstery spring, a method for producing an upholstery spring, in particular for upholstered furniture or mattresses, and also a mattress and an item of upholstered furniture.

DE 10 2013 103 644 discloses a spring of a spring core consisting of wire, which can be used for mattresses or upholstered furniture, for example. The spring consists of a spring steel wire wound into a spiral, which deforms upon load. Such springs have proven themselves in the production of upholstered furniture and mattresses, wherein the springs are heat-treated during the production to make them tougher. Sagging of individual springs and depressions resulting therefrom, such as hollows in upholstery or mattresses, are prevented by such a heat treatment. However, it can only be established with great effort whether sufficient heat treatment has been carried out. Checking is generally not possible for the final customer.

Subsequently published DE 10 2015 102 539 A1 discloses a method for producing an upholstery spring. The upholstery spring is formed from a spring steel wire and has a color indicator, which indicates whether sufficient heat treatment has been performed to anneal the upholstery spring.

Proceeding from this prior art, it is the object of the present invention to improve the upholstery spring such that the ductility of the spring is improved and at the same time adhesion of the color indicator is ensured, and to provide a method for producing such an upholstery spring.

The invention achieves this object by way of an upholstery spring having the features of claim 1 and by way of a method having the features of claim 6.

An upholstery spring according to the invention comprises a spring steel wire made of a micro-alloyed steel and a color indicator arranged in at least some regions thereon, wherein the microalloyed steel has one or more alloy elements between 0.004 to 0.015 wt. %.

In one preferred embodiment, the color indicator is therefore not a component of the material of the spring steel wire, but rather the color indicator is applied to this spring steel wire.

Microalloyed steels comprise, usually in small weight proportions, alloy elements such as aluminum, titanium, vanadium, or niobium. Some of these alloy elements can form carbides or nitrides. So-called grain refinement can particularly preferably also occur, in which smaller and finer grains are produced in the microstructure. This is accompanied by a heat treatment, due to which the formation of the finer grains occurs in the microstructure as a result of the grain refinement.

This grain refinement of the microstructure can in turn have a positive effect on the toughness and ductility of the spring steel wire, which is then linked to improved deformation properties.

Moreover, the strength can be optimized and an improvement of the drawing properties can occur due to the secure binding of the nitrogen to titanium.

In addition, it has been shown that good bonding of the color indicator, in particular a copper-containing coating, to the microalloyed steel is possible.

Advantageous embodiment variants of an upholstery spring according to the invention are the subject matter of the dependent claims.

It is advantageous if the spring steel consists of a titanium-microalloyed steel having a titanium proportion between 0.004 to 0.01 wt. %. The microstructure of the spring steel wire and the microstructure of the final product is influenced by the addition of titanium. By adding titanium as an alloy element, the formation of a finer-grain microstructure than other known spring steel wires can occur, in particular due to grain refinement, preferably in the scope of a heat treatment during the production of the spring steel wire.

Optimum results have been achieved insofar as the titanium proportion in the titanium-microalloyed steel is between 0.005 to 0.008 wt. %.

The color indicator can advantageously be applied to the spring steel wire as a copper-containing coating, in particular as a coating consisting of copper. A copper-containing coating is to be understood as a coating which has a certain copper proportion to a certain mass proportion. Furthermore, for example, a binder can be part of the coating. This can be a lacquer or a metal matrix in the case of a coating alloy. The copper-containing coating should advantageously not influence the mechanical properties of the upholstery spring in a disadvantageous manner. The copper-containing coating can also substantially completely consist of copper, which is applied with a low layer thickness to the spring steel wire. It is also possible to use suitable copper alloys, in order to set a certain changeover temperature. During the color change, the copper-colored coating becomes darker or lighter depending on the temperature reached, which is visually well recognizable.

The spring steel wire can be formed on the basis of a steel for a wire rod for drawing according to DIN EN ISO 16120 of the steel types C38(D) to C70(D), which has additionally been alloyed with titanium, in particular in the above-mentioned preferred concentration ranges.

A method according to the invention for producing an upholstery spring, in particular for upholstered furniture or mattresses, comprises, inter alia, the step of providing a bent or unbent spring steel wire made of microalloyed steel, wherein the microalloyed steel has at least one or more alloy elements between 0.001 and 0.015 wt. %.

Furthermore, the method provides according to the invention that a heat-sensitive color indicator is applied in at least some regions to a spring steel wire before, during, or after the bending of the spring steel wire, and then the spring steel wire is heated to at least the changeover temperature of the color indicator, before the upholstery spring is finished. There are machines which carry out heating during the wire drawing before the winding of the spring, and therefore the spring is wound hot. However, there are also machines which heat by way of the introduction of current in a second step, whereby the spring is already wound.

It is ensured by the application of the heat-sensitive color indicator that the heat treatment of the spring steel wire can be made optically visible. By way of a corresponding color change it is recognizable both for the producer of upholstered furniture and mattresses and also for the final customer whether a heat treatment has been performed, which makes the spring steel wire tougher. An important quality criterion for upholstery springs can thus be optically emphasized.

The provision of the spring steel wire can advantageously comprise a micro-alloying of spring steel with titanium and/or a titanium compound during a hot rolling procedure, such that a change of the fine grain structure of the steel during a subsequent cooling to a spring steel body takes place due to the quantity of the added titanium and/or the added titanium compound. The change of the fine grain structure of the steel relates in this case to a comparison in relation to a steel which is not microalloyed with titanium or a titanium compound. Titanium is to be understood as the elementary metal in this case. A metal compound can be, for example, a titanium salt, for example, a carbide or nitride, or a titanium alloy.

The provision of the spring steel wire can moreover comprise forming, preferably at temperatures of less than 50° C., by drawing of the spring steel body to form the spring steel wire. This forming is also known as the cold drawing method.

The color indicator can now be applied following this drawing procedure.

Bending and/or winding of the spring steel wire into the form of the upholstery spring can take place before or after the application of the color indicator.

The spring steel wire is preferably heated to greater than 280° C. during the heat treatment. For the heat treatment, the spring steel wire can be heated, for example, to a temperature between 290° C. to 310° C., wherein the duration of the heat treatment can be made dependent on the spring steel wire used, but the temperature greater than 290° C. has to be reached at least briefly. The changeover temperature of the color indicator is therefore preferably also at least 250° C., in particular between 290° C. and 310° C. The positive effects due to the heat treatment occur at these temperatures.

For effective production of the upholstery springs, the color indicator can be applied by an immersion bath. The coating can preferably take place solely electrochemically or galvanically with application of a voltage in this case. The color indicator preferably has a thickness between 0.05 and 1 μm, in particular 0.10 and 0.80 μm, and therefore the color indicator is only applied in small quantities to the spring steel wire.

In a further embodiment of the invention, the color indicator is only applied in some regions to the spring steel wire, which is particularly material-saving. The color indicator can be applied, for example, only to a middle region of the upholstery spring, which deforms upon load, and therefore it is at least made visible by the color indicator whether the deforming region is heat-treated. End rings of an upholstery spring arranged on opposing sides can then remain uncoated. Of course, it is also possible to coat the upholstery spring completely with the color indicator.

An upholstery spring, which is used in particular in a mattress or an item of upholstered furniture, is also provided according to the invention. In a mattress or an item of upholstered furniture, it is possible that a viewing window is provided in a cover for the upholstery spring or a unit made of multiple upholstery springs, and therefore a final customer can also recognize whether the upholstery spring was heat treated appropriately.

The invention will be explained in greater detail hereafter on the basis of an exemplary embodiment with reference to the appended drawings. In the figures:

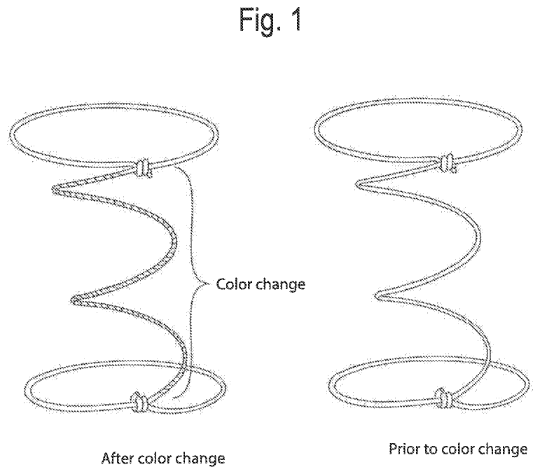

FIG. 1 shows a photographic view of an upholstery spring having a coating of a color indicator according to the invention, before and after the heat treatment, and

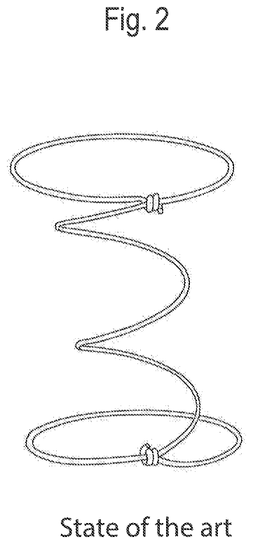

FIG. 2 shows a conventional upholstery spring without color indicator.

FIG. 2 shows an upholstery spring without a coating made of a heat-sensitive color indicator. It is recognizable that the spring steel wire, from which the upholstery spring is produced, has the same color everywhere and it is visually not recognizable whether a heat treatment was carried out in this upholstery spring to make the spring steel wire tougher.

An upholstery spring according to the present invention is shown on the left side in FIG. 1.

The upholstery spring has a spring steel wire, which consists of a microalloyed steel having alloy elements in the scope of 0.004 to 0.015 wt. %.

Titanium has proven to be a particularly preferred alloy element. The titanium content can preferably be 0.004 to 0.01 wt. % and optimally 0.005 wt. % to 0.008 wt. %.

The spring steel wire preferably consists in this case of a steel which is essentially a carbon steel and is particularly preferably based on the steel qualities C38(D) to C70(D).

The provision of the wire can be performed such that the fine grain structure of the steel is influenced already in the steel mill by microalloying and a special cooling process after the hot rolling. In contrast to a non-microalloyed spring steel wire, a formation of a grain refinement occurs here. Firstly, a spring steel body is formed, which can subsequently be formed by drawing into a spring steel wire, for example, in the scope of cold forming.

A coating with a color indicator can be performed subsequently, which will be described in detail hereafter.

The upholstery spring is wound in a spiral in a middle region between two end rings arranged in parallel and is coated with a heat-sensitive color indicator in this middle region. As can be inferred from the view, the middle region has a different color than the two uncoated end rings of the upholstery spring. The middle region is clearly darker, which is because of the color change of the heat-sensitive color indicator as a result of a heat treatment. An upholstery spring with color indicator and without heat treatment is shown on the right side. It can be seen clearly that the color is uniform. A copper-containing coating in a thickness between 0.15 μm to 0.75 μm was electrochemically applied to the wire as the heat-sensitive color indicator on the middle region. For this purpose, the wire was guided through an immersion bath and at the same time a voltage was applied to the spring steel wire, and therefore the copper-containing coating was deposited on the surface. The layer thickness and the coated regions may be set comparatively exactly by this method.

The color indicator can have been applied in this case to the still unformed spring steel wire, and therefore it is only formed into the shape of an upholstery spring after the coating. A complete coating is then preferably performed. However, it is also possible to firstly form the spring steel wire into an upholstery spring and to at least partially coat the already formed spring steel wire.

After the application of the color indicator, the bent spring steel wire was subjected to a heat treatment, wherein the bent spring steel wire was heated to a temperature between 280° C. and 320° C. The color indicator was activated by the heating to this temperature, and therefore a visually recognizable color change was performed in the middle region.

In the illustrated exemplary embodiment, only the middle region of an upholstery spring is coated with a color indicator, wherein it is also possible to apply the color indicator completely to the upholstery spring. However, it is simpler to visually recognize the color change due to the heat treatment by way of the coating of the color indicator in some regions. Moreover, it is possible to provide the coating only in the region of the upholstery spring which deforms upon load, i.e., in particular the region between the two end rings.

The upholstery spring can be bent into different spring types. The upholstery spring can thus be formed as a Bonell spring, pocket spring, open coil, or another spring type. The upholstery springs can also be assembled into units made of multiple upholstery springs and then processed into mattresses or upholstered furniture.

In order that the final customer can check whether high-quality upholstery springs have been used in the mattress or the upholstered furniture, at least one viewing window, which is transparent or formed by an opening, can be provided in the cover, and therefore a visual check is possible as to whether the upholstery spring is heat treated.

After the application of the color indicator, winding and/or bending of the upholstery spring from the spring steel wire can take place.

The finished upholstery spring can optionally be enclosed thereafter in material pockets, for example, of a mattress or an item of upholstered furniture.

Finally, a connection of the upholstery springs or material pockets to spring cores can be performed and these can be installed in a bed or item of upholstered furniture.

An influence on the microstructure of the hot-rolled spring steel body of the spring steel wire and also on the microstructure of the final product is also to be expected by the addition of titanium, since in this way a finer-grain microstructure is generally formed.

This effect, which is known as grain refinement, can have a positive effect on the toughness and ductility of the spring steel wire of the upholstery spring, which is then linked to better deformation properties.

Moreover, an influence on the strength is thus frequently also to be reserved and the drawing properties can be improved by the secure binding of the nitrogen to titanium, and therefore the processing capability during the cold forming to provide the spring steel wire can be improved.

In this case, in particular a titanium microalloy has a positive influence on the material properties of the spring steel wire.

A high affinity to nitrogen thus results in its binding, which enhances the aging resistance of the spring steel. The setting loss of upholstery springs can thus also be reduced.

Furthermore, the fine titanium precipitations have a grain-refining action, which has a positive effect on the ductility of the steel, which in turn has advantages in the production of the upholstery spring.

1. An upholstery spring comprising a spring steel wire made of a microalloyed steel and a color indicator arranged in at least some regions thereon, wherein the microalloyed steel has one or more alloy elements between 0.004 and 0.015 wt. %.

2. The upholstery spring according to claim 1, characterized in that the spring steel consists of a titanium-microalloyed steel having a titanium proportion between 0.004 and 0.01 wt. %.

3. The upholstery spring according to claim 1, characterized in that the spring steel consists of a titanium-microalloyed steel having a titanium proportion between 0.005 and 0.008 wt. %.

4. The upholstery spring according to claim 1, characterized in that the color indicator is applied to the spring steel wire as a copper-containing coating, in particular as a coating consisting of copper.

5. The upholstery spring according to claim 1, characterized in that the steel is based on a steel of the steel types C38(D) to C70(D) and additionally has titanium as an alloy element.

6. A method for producing an upholstery spring, in particular for upholstered furniture or mattresses, having at least the following steps:
providing a bent or unbent spring steel wire made of microalloyed steel, wherein the microalloyed steel has one or more alloy components between 0.001 and 0.015 wt. %;
applying a heat-sensitive color indicator in at least some regions to a spring steel wire before, during, or after a bending of the spring steel wire;
heating of the spring steel wire to at least the changeover temperature of the color indicator; and
finishing the upholstery spring.

7. The method according to claim 6, characterized in that the provision of the spring steel wire comprises microalloying of spring steel with titanium and/or a titanium compound during a hot rolling procedure such that a change of the grain refinement of the steel takes place during subsequent cooling to form a spring steel body due to the quantity of the added titanium and/or the added titanium compound.

8. The method according to claim 6, characterized in that the provision of the spring steel wire comprises forming, preferably at temperatures of less than 50° C., by drawing the spring steel body to form the spring steel wire.

9. The method according to claim 6, characterized in that the spring steel wire, after the provision of the bent or unbent spring steel wire and after the application in at least some regions of the heat-sensitive color indicator, is heated to greater than 250° C., preferably to a temperature between 280° C. and 320° C., for a heat treatment and an activation of the color indicator.

10. The method according to claim 6, characterized in that the color indicator is applied with a thickness between 0.05 μm and 1.5 μm, in particular 0.10 μm and 0.80 μm.

11. The method according to claim 6, characterized in that the color indicator is applied to die spring steel wire only in some regions, in particular to a middle region of the upholstery spring.

12. The upholstery spring according to claim 1, characterized in that the upholstery spring is produced by a method according to claim 6.

13. Upholstered furniture or mattress having an upholstery spring according to claim 1.

14. Upholstered furniture or mattress according to claim 13, characterized in that a viewing window is provided on a cover for the upholstery spring or a unit made of multiple upholstery springs.
